(19) United States
(12) Patent Application Publication
(10) Pub. No.: US 2026/0094828 A1
(43) Pub. Date: Apr. 2, 2026

(54) NEGATIVE ELECTRODE OF SECONDARY BATTERY, AND SECONDARY BATTERY USING THE NEGATIVE ELECTRODE

(71) Applicant: Prime Planet Energy & Solutions, Inc., Tokyo (JP)

(72) Inventor: Naoto ONODERA, Kobe-shi (JP)

(21) Appl. No.: 19/325,496

(22) Filed: Sep. 11, 2025

(30) Foreign Application Priority Data
Sep. 27, 2024 (JP) 2024-169482

(51) Int. Cl. H01M 4/587; H01M 4/02; H01M 4/133; H01M 4/36; H01M 4/62

(52) U.S. Cl. CPC H01M 4/587; H01M 4/133; H01M 4/366; H01M 4/625; H01M 2004/027

(57) ABSTRACT

The negative electrode includes a negative electrode current collector, and a negative electrode active material layer supported by the negative electrode current collector. The negative electrode active material layer includes a first layer existing on a side of a surface layer part and a second layer existing on a side of the negative electrode current collector. The first layer includes first graphite particles and first Si-containing particles. The second layer includes second graphite particles and second Si-containing particles. The Si content ratio in the first Si-containing particle is smaller than that in the second Si-containing particle. Each of the first Si-containing particle and the second Si-containing particle is coated with a conductive material. The ratio of the coating amount (mass %) of the conductive material for the second Si-containing particle to the coating amount (mass %) of the conductive material for the first Si-containing particle is 2.5 or more.

### CROSS-REFERENCE TO RELATED APPLICATIONS

The present disclosure relates to a negative electrode of a secondary battery. The present disclosure also relates to a secondary battery using the negative electrode. This application claims the benefit of priority to Japanese Patent Application No. 2024-169482 filed on Sep. 27, 2024. The entire contents of this application are incorporated herein by reference.

### BACKGROUND

In recent years, secondary batteries have been suitably used for portable power sources of personal computers, mobile terminals, and the like, driving power sources of vehicles such as a battery electric vehicle (BEV), a hybrid electric vehicle (HEV), and a plug-in hybrid vehicle (PHEV), and the like.

In the applications for the driving power sources of vehicles, particularly in the applications for the driving power sources of BEVs, the secondary batteries are demanded to have higher capacity from the viewpoint of extending the cruising distance of the vehicle. As a negative electrode active material with high capacity, Si-containing particles are known, and it has been known that using the Si-containing particles can increase the capacity of the secondary battery (for example, see Japanese Patent Application Publication No. 2015-38862). In the art disclosed in Japanese Patent Application Publication No. 2015-38862, the Si-containing particles and graphite particles such as natural graphite are used in combination as the negative electrode active material.

### SUMMARY

However, while the Si-containing particle has high capacity, the change in volume due to expansion/shrinkage when the secondary battery is charged and discharged is large. When the Si-containing particles and the graphite particles are used in combination as the negative electrode active material, repeating the charging and discharging of the secondary battery causes a negative electrode to expand, which leads to a problem that the internal stress increases. Therefore, it has been demanded to develop a negative electrode including the Si-containing particles and the graphite particles, whose expansion when the secondary battery is charged and discharged repeatedly is small. It should be noted that this expansion of the negative electrode means that, in the same state of charge (for example, discharged state), the volume of the negative electrode becomes larger than the initial volume.

In view of the above circumstances, it is an object of the present disclosure to provide a negative electrode including Si-containing particles and graphite particles, whose expansion when a secondary battery is charged and discharged repeatedly is small.

A negative electrode of a secondary battery according to the present disclosure includes a negative electrode current collector, and a negative electrode active material layer supported by the negative electrode current collector. The negative electrode active material layer includes a first layer existing on a side of a surface layer part and a second layer existing on a side of the negative electrode current collector. The first layer includes first graphite particles and first Si-containing particles. The second layer includes second graphite particles and second Si-containing particles. The Si content ratio in the first Si-containing particle is smaller than the Si content ratio in the second Si-containing particle. Each of the first Si-containing particle and the second Si-containing particle is coated with a conductive material. The ratio of the coating amount (mass %) of the conductive material for the second Si-containing particle to the coating amount (mass %) of the conductive material for the first Si-containing particle is 2.5 or more.

With such a constitution, the negative electrode including the Si-containing particles and the graphite particles, whose expansion when the secondary battery is charged and discharged repeatedly is small can be provided.

In another aspect, a secondary battery disclosed herein includes a positive electrode, a negative electrode, and an electrolyte. The negative electrode is the aforementioned negative electrode.

With such a constitution, the secondary battery using the negative electrode including the Si-containing particles and the graphite particles, in which the expansion of the negative electrode when the secondary battery is charged and discharged repeatedly is small can be provided.

### BRIEF DESCRIPTION OF THE DRAWINGS

FIG. 1 is a cross-sectional view schematically illustrating a structure of a negative electrode of a secondary battery according to one embodiment of the present disclosure;

FIG. 2 is a cross-sectional view schematically illustrating a structure of particles of a negative electrode active material included in a negative electrode active material layer of the negative electrode in FIG. 1;

FIG. 3 is a cross-sectional view schematically illustrating a structure of a lithium ion secondary battery constructed using the negative electrode of the secondary battery according to one embodiment of the present disclosure; and

FIG. 4 is a schematic exploded view illustrating a structure of a wound electrode body of the lithium ion secondary battery in FIG. 3.

### DETAILED DESCRIPTION

Embodiments of the present disclosure will hereinafter be described with reference to the drawings. Matters that are not mentioned in the present specification and that are necessary for the implementation of the present disclosure can be grasped as design matters of those skilled in the art based on the prior art in the relevant field. The present disclosure can be implemented on the basis of the contents disclosed in the present specification and common technical knowledge in the relevant field. It should be noted that in the drawings below, the members and parts with the same operation are explained by being denoted by the same reference sign. In addition, the size relation (length, width, thickness, etc.) in each drawing does not necessarily reflect the actual size relation. Moreover, in the present specification, the numerical range expressed as “A to B” includes A and B.

It should be noted that the term “secondary battery” in this specification refers to an electrical energy storage device capable of being charged and discharged repeatedly. It should be noted that, in the present specification, the term “lithium ion secondary battery” refers to a secondary battery that uses lithium ions as a charge carrier and can be charged and discharged by transfer of charges accompanying with the lithium ions between positive and negative electrodes.

A negative electrode disclosed herein is used for a secondary battery, and is suitably used for a lithium ion secondary battery. One embodiment of the negative electrode disclosed herein is described specifically with reference to FIG. 1. FIG. 1 is a cross-sectional view schematically illustrating one example of a negative electrode 60 according to this embodiment, and is a cross-sectional view taken along a thickness direction and a width direction. The negative electrode 60 according to this embodiment illustrated in FIG. 1 is a negative electrode of a lithium ion secondary battery.

As illustrated in the drawing, the negative electrode 60 includes a negative electrode current collector 62, and a negative electrode active material layer 64 supported by the negative electrode current collector 62. In other words, the negative electrode 60 includes the negative electrode current collector 62 and the negative electrode active material layer 64 provided on the negative electrode current collector 62. The negative electrode active material layer 64 may be provided on only one surface of the negative electrode current collector 62, or may be provided on both surfaces of the negative electrode current collector 62 as illustrated in the drawing. It is desirable that the negative electrode active material layer 64 be provided on both surfaces of the negative electrode current collector 62.

A negative electrode active material layer non-formation part 62a, in which the negative electrode active material layer 64 is not provided, may be provided at one end part of the negative electrode 60 in the width direction as illustrated in the drawing. In the negative electrode active material layer non-formation part 62a, the negative electrode current collector 62 is exposed and the negative electrode active material layer non-formation part 62a can function as a current collecting part. However, a structure for collecting current from the negative electrode 60 is not limited to this structure.

The shape of the negative electrode current collector 62 is a foil shape (or sheet shape) in the illustrated example; however, the shape is not limited to this shape. The negative electrode current collector 62 may have various modes such as a stick shape, a plate shape, and a mesh shape. As a material of the negative electrode current collector 62, metals with excellent conductivity (for example, copper, nickel, titanium, stainless steel, and the like) can be used similarly to the conventional lithium ion secondary battery, and in particular, copper is desirable. As the negative electrode current collector 62, a copper foil is particularly desirable.

The size of the negative electrode current collector 62 is not limited in particular and may be determined as appropriate in accordance with the battery design. In the case of using the copper foil as the negative electrode current collector 62, the thickness thereof is not limited in particular and is for example 5 μm or more and 35 μm or less and desirably 6 μm or more and 20 μm or less.

As illustrated in FIG. 1, the negative electrode active material layer 64 has a multilayer structure, and specifically includes a first layer 64a existing on a side of a surface layer of the negative electrode active material layer 64, and a second layer 64b existing on a side of the negative electrode current collector 62. As illustrated in FIG. 1, the first layer 64a is an upper layer of the negative electrode active material layer 64 and the second layer 64b is a lower layer of the negative electrode active material layer 64. It should be noted that the negative electrode active material layer 64 may further include a layer other than the first layer 64a and the second layer 64b within the range not interrupting the effect of the present disclosure remarkably. For example, the negative electrode active material layer 64 may include, between the first layer 64a and the second layer 64b, an intermediate layer where components of these layers are mixed.

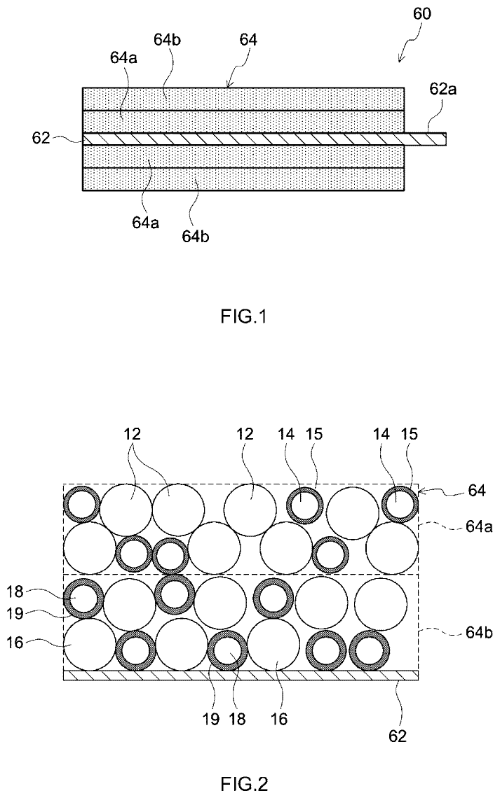

The negative electrode active material layer 64 includes a negative electrode active material. This will be described in detail with reference to FIG. 2. FIG. 2 is a schematic cross-sectional view illustrating particles of the negative electrode active material included in the negative electrode active material layer 64 illustrated in FIG. 1. It should be noted that since FIG. 2 is the schematic view, the number of particles, the distribution, and the like are not limited to those illustrated in FIG. 2.

Regarding the negative electrode active material, the first layer 64a includes first graphite particles 12 and first Si-containing particles 14. The second layer 64b includes second graphite particles 16 and second Si-containing particles 18. Therefore, in the first layer 64a, at least the first graphite particles 12 and the first Si-containing particles 14 are used as the negative electrode active material and in the second layer 64b, at least the second graphite particles 16 and the second Si-containing particles 18 are used as the negative electrode active material. The volume change of the Si-containing particle due to the expansion/shrinkage along with the charging and discharging is large; however, using the graphite particles in combination makes it possible to suppress the disconnection of a conductive path due to the volume change of the Si-containing particle.

Graphite that forms the first graphite particles 12 and the second graphite particles 16 may be either natural graphite or artificial graphite, and may be amorphous carbon-coated graphite in which graphite is coated with an amorphous carbon material.

The shape of the first graphite particle 12 and the second graphite particle 16 is not limited in particular and may be a flake shape, a spherical shape, or the like. The first graphite particle 12 and the second graphite particle 16 are desirably spherical graphite particles. When the first graphite particle 12 and the second graphite particle 16 are spherical, the first graphite particle 12 and the second graphite particle 16 have a circularity of desirably 0.85 to 1, more desirably 0.88 to 1, and still more desirably 0.90 to 1.

It should be noted that in this specification, the term “circularity” refers to the ratio of a circumferential length of a perfect circle with the same area as the projection area of a particle to a circumferential length of a particle projection image (that is, circularity=the circumferential length of a perfect circle with the same area as the projection area of a particle/the circumferential length of a particle projection image). Therefore, as the circularity is closer to 1, it means that the particle projection image is closer to a perfect circle and the particle is closer to a perfect sphere. The circularity can be determined in such a way that, for example, the circularities of 100 or more particles are obtained using a commercial static automated image analysis device and the average value thereof is calculated.

An average particle diameter (D50) of the first graphite particles 12 and the second graphite particles 16 is not limited in particular. The average particle diameter (D50) of each of the first graphite particles 12 and the second graphite particles 16 is for example 1 μm to 30 μm, desirably 5 μm to 25 μm, more desirably 10 μm to 23 μm, and still more desirably 12 μm to 20 μm.

It should be noted that, in the present specification, the term “average particle diameter (D50)” refers to the median diameter (D50), which means the particle diameter corresponding to the cumulative frequency 50 vol % from the microparticle side with small particle diameter in the particle size distribution based on the volume in accordance with a laser diffraction/scattering method. The average particle diameter (D50) can be obtained using a commercial laser diffraction/scattering type particle size distribution measurement device or the like.

The first graphite particle 12 and the second graphite particle 16 may be the same graphite particles or different graphite particles. As the first graphite particle 12 and the second graphite particle 16, the same graphite particles are desirably used.

As the first Si-containing particle 14 and the second Si-containing particle 18, for example, particles of a Si—C composite material can be used. The Si—C composite material typically includes a carbon domain and a Si-containing domain. It should be noted that the first Si-containing particle 14 and the second Si-containing particle 18 are not necessarily formed of the Si—C composite material and may be a Si particle, a Si oxide particle, or the like.

Examples of the carbon domain include a carbonized product of a carbon precursor (for example, petroleum pitch, coal pitch, phenol resin, or the like), graphite, and the like. The carbon domain desirably forms a carbon matrix. Therefore, the Si—C composite material is desirably a material in which a plurality of Si-containing domains are dispersed in a carbon matrix. This case is advantageous because the carbon matrix can relieve the volume change due to the expansion/shrinkage of the Si-containing domain.

The Si-containing domain includes Si, and for example, is formed of Si, Si oxide (SiOₓ), Si nitride (SiNₓ), Si carbide (SiCₓ), or the like. The Si-containing domain is desirably formed of at least one of Si or Si oxide (SiOₓ). The Si-containing domain may be a microparticle. The Si-containing domain has an oxygen content of desirably 10 mass % or less.

The Si-containing domains may have an average particle diameter of for example 50 nm or less, or 5 nm to 50 nm. It should be noted that “the average particle diameter of the Si-containing domains” can be determined as follows. First, the negative electrode active material layer 64 is subjected to focused ion beam (FIB) processing, so that a sample for scanning transmission electron microscope (STEM) observation is prepared. Then, after the sample is subjected to an elemental analysis with EDX element mapping, a bright field (BF) image and a high-angle annular dark field (HAADF) image are acquired. Based on the contrast and shape obtained by the BF image and the HAADF image, the diameter of the Si-containing domain can be determined. The diameters of 10 or more Si-containing domains that are arbitrarily selected are determined and the average value thereof is defined as “the average particle diameter of the Si-containing domains” here.

The Si—C composite material is, for example, a material in which microparticles containing Si are dispersed inside a carbon material, a material in which microparticles containing Si get into pores of granulated porous graphite, or the like. The Si—C composite material may be a material in which a microparticle containing Si adheres to a surface of a carbon particle, a material in which a carbon microparticle adheres to a surface of a particle containing Si, or the like. From the viewpoint of suppressing the volume change of Si, it is desirable to use a material in which Si nanoparticles are dispersed inside a carbon material, and a material in which Si nanoparticles are dispersed inside pores of a porous carbon material, and more desirable to use the material in which the Si nanoparticles are dispersed inside the pores of the porous carbon material.

In this embodiment, a Si content ratio (S1) in the first Si-containing particle 14 is lower than a Si content ratio (S2) in the second Si-containing particle 18. As long as this relation is satisfied, the Si content ratio (S1) in the first Si-containing particle 14 and the Si content ratio (S2) in the second Si-containing particle 18 are not limited in particular. However, if these Si content ratios are too low, the effect of suppressing the expansion of the negative electrode when the secondary battery is repeatedly charged and discharged may become low. On the other hand, if these Si content ratios are too high, the volume change due to the expansion/shrinkage of the first Si-containing particle 14 and the second Si-containing particle 18 when the secondary battery is repeatedly charged and discharged may become too large.

Therefore, the Si content ratio (S1) in the first Si-containing particle 14 is desirably 20 mass % to 55 mass %, and more desirably 25 mass % to 45 mass %. The Si content ratio (S2) in the second Si-containing particle 18 is desirably 45 mass % to 80 mass %, and more desirably 55 mass % to 75 mass %.

In addition, a ratio (S1/S2) of the Si content ratio (S1) in the first Si-containing particle 14 to the Si content ratio (S2) in the second Si-containing particle 18 is desirably 0.10 to 0.90, more desirably 0.20 to 0.80, and still more desirably 0.40 to 0.75.

The average particle diameters (D50) of the first Si-containing particles 14 and the second Si-containing particles 18 are not limited in particular. The average particle diameter (D50) of each of the first Si-containing particles 14 and the second Si-containing particles 18 is for example 1 μm to 15 μm, desirably 2 μm to 10 μm, and more desirably 4 μm to 10 μm.

It should be noted that the first Si-containing particle 14 and the second Si-containing particle 18 can be manufactured in accordance with a known method. It should be noted that various manufacturing methods for particles of the Si—C composite material are known (for example, see Japanese Patent Application Publication No. 2015-38862, WO 2014/046144, prior art documents mentioned in WO 2014/046144, etc.).

As illustrated in FIG. 2, the first layer 64a includes a first conductive material 15. In the first layer 64a, the first Si-containing particle 14 is coated with the first conductive material 15. In addition, the second layer 64b includes a second conductive material 19. In the second layer 64b, the second Si-containing particle 18 is coated with the second conductive material 19.

In the illustrated example, the entire first Si-containing particle 14 and the entire second Si-containing particle 18 are coated with the first conductive material 15 and the second conductive material 19, respectively. Therefore, each of the first conductive material 15 and the second conductive material 19 forms a coating layer. However, the first Si-containing particle 14 and the second Si-containing particle may be partially coated with the first conductive material 15 and the second conductive material 19, respectively.

Examples of the conductive material (that is, the first conductive material 15 and the second conductive material 19) include carbon black such as acetylene black, carbon fiber, carbon nanotubes (CNTs), and the like. In particular, the CNT is desirable. It should be noted that the first conductive material 15 and the second conductive material 19 are desirably the same conductive material.

In the case of using the CNT as the conductive material, the kind thereof is not limited in particular and for example, a single-walled carbon nanotube (SWCNT), a double-walled carbon nanotube (DWCNT), and a multi-walled carbon nanotube (MWCNT), and the like can be used. Any of these can be used alone or two or more kinds thereof can be used in combination. Since more conductive paths between the negative electrode active materials can be formed, the SWCNT is desirable as the CNT. The CNT may be manufactured in accordance with an arc discharge method, a laser ablation method, a chemical vapor deposition method, or the like.

The average length of the CNTs is not limited in particular. If the average length of the CNTs is too long, it is likely that the CNTs aggregate and the dispersibility decreases. Thus, the average length of the CNTs is desirably 15 μm or less, more desirably 8.0 μm or less, and still more desirably 5.0 μm or less. On the other hand, if the average length of the CNTs is too short, the conductive paths between the negative electrode active materials tend to be formed less easily. Thus, the average length of the CNTs is desirably 0.3 μm or more, more desirably 0.5 μm or more, and still more desirably 1.0 μm or more.

The average diameter of the CNTs is not limited in particular, and is for example 0.1 nm to 50 nm and desirably 0.3 nm to 30 nm.

It should be noted that the average length and the average diameter of the CNTs can be determined by acquiring an electron microscope image of the CNTs and calculating average values of the lengths and the diameters of 100 or more CNTs, respectively. In the specific example, a CNT dispersion liquid is diluted and then dried, so that a measurement sample is prepared. This sample is observed by a scanning electron microscope (SEM), the lengths and the diameters of 100 or more CNTs are obtained, and the average values are calculated. In this case, if the CNTs reaggregate, the length and the diameter are obtained for a bundle of the aggregated CNTs.

In this embodiment, a coating amount (C1) (mass %) of the first Si-containing particle 14 with the first conductive material 15 is smaller than a coating amount (C2) (mass %) of the second Si-containing particle 18 with the second conductive material 19. It should be noted that the coating amount (C1) is the ratio (%) of the mass of the first conductive material 15 to the mass of the first Si-containing particle 14, and the coating amount (C2) is the ratio (%) of the mass of the second conductive material 19 to the mass of the second Si-containing particle 18.

Then, a ratio (C2/C1) of the coating amount (C2) of the conductive material for the second Si-containing particle to the coating amount (C1) of the conductive material for the first Si-containing particle is 2.5 or more.

In this manner, in the first layer 64a, which is the upper layer of the negative electrode active material layer 64, the first Si-containing particle 14 with the low Si content ratio coated with the first conductive material 15 is used in addition to the first graphite particle 12, and in the second layer 64b, which is the lower layer of the negative electrode active material layer 64, the second Si-containing particle 18 with the high Si content ratio coated with the second conductive material 19 with the coating amount 2.5 times or more larger than that of the first Si-containing particle 14 is used in addition to the second graphite particle 16. Consequently, the expansion of the negative electrode 60 when the secondary battery is charged and discharged repeatedly can be remarkably suppressed. The reason is considered as below.

That is to say, in the negative electrode active material layer 64, it is the upper layer (that is, the first layer 64a) that expands more when the secondary battery is repeatedly charged and discharged. Therefore, in the upper layer, the Si-containing particle having the low Si content ratio and thereby having the small expansion and shrinkage is used and additionally, this particle is coated with a relatively small amount of conductive material. Thus, a side reaction and the expansion and shrinkage of the Si-containing particle due to the charging and discharging can be suppressed.

On the other hand, in the lower layer (that is, the second layer 64b), the Si-containing particle having the high Si content ratio and thereby having the large expansion and shrinkage is used and moreover, this particle is coated with a relatively large amount of conductive material. Thereby, the disconnection of the conductive path at the charging and discharging of the secondary battery can be suppressed. Accordingly, the expansion of the negative electrode due to the disconnection of the conductive path (that is, the expansion caused because the battery reaction becomes inhomogeneous and the reaction or stress concentrates locally, for example) can be suppressed. Consequently, in the entire negative electrode active material layer 64, the expansion of the negative electrode 60 when the charging and discharging of the secondary battery are repeated can be suppressed remarkably.

The ratio of the coating amount (C2/C1) is desirably 2.8 or more, more desirably 3.0 or more, still more desirably 5.0 or more, and particularly desirably 7.0 or more. The ratio of the coating amount (C2/C1) may be 50 or less, 30 or less, 20 or less, or 15 or less.

The content of the conductive material in the negative electrode active material layer 64 (that is, the first layer 64a and the second layer 64b) is not limited in particular as long as the effect of the present disclosure can be obtained. The amount of the conductive material is for example, 0.02 mass % to 10 mass % with respect to the negative electrode active material, and may be determined as appropriate in accordance with the kind of the conductive material. When the conductive material is the CNT, the content of the conductive material in the negative electrode active material layer 64 is desirably 0.02 mass % to 3.0 mass % and more desirably 0.05 mass % to 1.0 mass % with respect to the negative electrode active material.

Thus, the coating amount (C1) of the first Si-containing particle 14 with the first conductive material 15 and the coating amount (C2) of the second Si-containing particle 18 with the second conductive material 19 may be determined as appropriate in consideration of the content of the conductive material in the negative electrode active material layer 64, the ratio of the coating amount (C2/C1), and the mass ratio of the first Si-containing particle 14 and the second Si-containing particle 18.

When the first conductive material 15 is the CNT, the coating amount (C1) of the first Si-containing particle 14 with the first conductive material 15 is, for example, 0.05 mass % to 2.0 mass %, desirably 0.05 mass % to 1.0 mass %, more desirably 0.05 mass % to 0.25 mass %, and particularly desirably 0.07 mass % to 0.24 mass %. When the second conductive material 19 is the CNT, the coating amount (C2) of the second Si-containing particle 18 with the second conductive material 19 is, for example, 0.10 mass % to 3.0 mass %, desirably 0.20 mass % to 1.5 mass %, more desirably 0.25 mass % to 0.70 mass %, and particularly desirably 0.27 mass % to 0.55 mass %.

The ratio of the total mass of the second conductive material 19 coating the second Si-containing particles 18 to the total mass of the first conductive material 15 coating the first Si-containing particles 14 is desirably more than 1, more desirably 1.5 or more, still more desirably 2 or more, and particularly desirably 4 or more.

It should be noted that a dispersant for the CNTs may adhere to the first conductive material 15 and the second conductive material 19. As the dispersant for the CNTs, a known dispersant for CNTs can be used.

In the first layer 64a, the mass ratio of the first Si-containing particles 14 to the total of the first graphite particles 12 and the first Si-containing particles 14 is desirably 10 mass % to 60 mass %, more desirably 15 mass % to 50 mass %, and still more desirably 20 mass % to 40 mass %.

In the second layer 64b, the mass ratio of the second Si-containing particles 18 to the total of the second graphite particles 16 and the second Si-containing particles 18 is desirably 10 mass % to 60 mass %, more desirably 15 mass % to 50 mass %, and still more desirably 20 mass % to 40 mass %. It should be noted that the mass ratio of the first Si-containing particles 14 in the first layer 64a and the mass ratio of the second Si-containing particles 18 in the second layer 64b may be either the same or different.

The negative electrode active material included in the first layer 64a may be only the first graphite particles 12 and the first Si-containing particles 14. However, the first layer 64a may further include the negative electrode active material other than the first graphite particles 12 and the first Si-containing particles 14 within the range not interrupting the effect of the present disclosure (for example, by 10 mass % or less of the total amount of the negative electrode active material included in the first layer 64a).

The negative electrode active material included in the second layer 64b may be only the second graphite particles 16 and the second Si-containing particles 18. However, the second layer 64b may further include the negative electrode active material other than the second graphite particles 16 and the second Si-containing particles 18 within the range not interrupting the effect of the present disclosure (for example, by 10 mass % or less of the total amount of the negative electrode active material included in the second layer 64b).

In the negative electrode active material layer 64, a ratio (T2/T1) of a thickness (T2) of the second layer 64b to a thickness (T1) of the first layer 64a is not limited in particular as long as the effect of the present disclosure can be obtained and is, for example, 5/95 to 95/5. From the viewpoint of further suppressing the expansion of the negative electrode when the secondary battery is repeatedly charged and discharged, the ratio (T2/T1) is desirably 10/90 to 90/10, more desirably 10/90 to 80/20, and still more desirably 30/70 to 60/40.

The negative electrode active material layer 64 may include a component other than the negative electrode active material and the conductive material, and examples of such a component include a binder. Examples of the binder include styrene butadiene rubber (SBR), carboxymethyl cellulose (CMC), polyacrylic acid (PAA), polyvinylidene fluoride (PVDF), and the like. CMC also functions as a thickener.

The content of the negative electrode active material in the first layer 64a (that is, with respect to the total mass of the first layer 64a) is desirably 90 mass % or more and more desirably 95 mass % or more. The content of the binder in the first layer 64a is desirably 0.1 mass % or more and 8 mass % or less, and more desirably 0.5 mass % or more and 5 mass % or less.

The content of the negative electrode active material in the second layer 64b (that is, with respect to the total mass of the second layer 64b) is desirably 90 mass % or more and more desirably 95 mass % or more. The content of the binder in the second layer 64b is desirably 0.1 mass % or more and 8 mass % or less, and more desirably 0.5 mass % or more and 5 mass % or less.

The thickness of the negative electrode active material layer 64 is not limited in particular and is, for example, 10 μm or more and 400 μm or less and desirably 20 μm or more and 300 μm or less.

The density of the negative electrode active material layer 64 is not limited in particular and is, for example, 0.7 g/cm³ or more, desirably 1.0 g/cm³ or more, and more desirably 1.2 g/cm³ or more. On the other hand, the density of the negative electrode active material layer 64 is, for example, 2.3 g/cm³ or less and may be 2.0 g/cm³ or less.

The negative electrode 60 may include a member other than the negative electrode current collector 62 and the negative electrode active material layer 64. For example, an insulating layer (not illustrated) adjacent to the negative electrode active material layer 64 may be provided on the negative electrode active material layer non-formation part 62a. The insulating layer contains, for example, an insulating inorganic filler or the like.

The negative electrode 60 can be manufactured suitably by a manufacturing method including the following steps, for example: a step (hereinafter also referred to as “coated particle preparing step”) of preparing the first Si-containing particle 14 coated with the first conductive material 15 and the second Si-containing particle 18 coated with the second conductive material 19, in which the Si content ratio (S1) in the first Si-containing particle 14 is lower than the Si content ratio (S2) in the second Si-containing particle 18, and the ratio of the coating amount (mass %) of the conductive material for the second Si-containing particle 18 to the coating amount (mass %) of the conductive material for the first Si-containing particle 14 is 2.5 or more; a step (hereinafter also referred to as “lower layer formation paste preparing step”) of preparing a lower layer formation paste by mixing the second Si-containing particle 18 coated with the second conductive material 19 and the second graphite particle 16 in a dispersion medium; a step (hereinafter also referred to as “upper layer formation paste preparing step”) of preparing an upper layer formation paste by mixing the first Si-containing particle 14 coated with the first conductive material 15 and the first graphite particle 12 in a dispersion medium; a step (hereinafter also referred to as “lower layer forming step”) of forming a lower layer by applying the lower layer formation paste on the negative electrode current collector 62 and drying the paste; and a step (hereinafter also referred to as “upper layer forming step”) of forming an upper layer by applying the upper layer formation paste on the lower layer and drying the paste.

It should be noted that the term “paste” in the present specification refers to a mixture in which a part or all of a solid content is dispersed in the dispersion medium, and encompasses so-called “slurry”, “ink”, and the like.

The coated particle preparing step can be performed in accordance with a known method. Specifically, for example, the first Si-containing particles 14 with the low Si content ratio and the second Si-containing particles 18 with the high Si content ratio are prepared. In addition, the conductive materials (the first conductive material and the second conductive material) are prepared. The first Si-containing particle 14 and the second Si-containing particle 18 can be coated with the conductive materials in accordance with a known coating method. Examples of such a method include: a method in which the Si-containing particles and the conductive material are dispersed in the dispersion medium and then, dried by heating, vacuuming, or the like as necessary; a method of spray-drying a slurry in which the Si-containing particles and the conductive material are dispersed in the dispersion medium; a method in which the Si-containing particles and the conductive material are subjected to a mechano-fusion process; a method in which the Si-containing particles and the conductive material are subjected to a mechanical milling process; a method in which the conductive material is deposited on the Si-containing particles by chemical vapor deposition (CVD); and the like.

It should be noted that the first Si-containing particle 14 and the second Si-containing particle 18 are covered with the conductive materials so that the ratio of the coating amount (C2/C1) is 2.5 or more.

The lower layer formation paste preparing step can be performed in accordance with a known method in such a way that the second graphite particles 16, the second Si-containing particles 18 coated with the second conductive material 19, and an optional component (for example, the binder or the like) are mixed with the dispersion medium (for example, water) using a known mixing device, stirring device, or the like.

The upper layer formation paste preparing step can be performed in accordance with a known method in such a way that the first graphite particles 12, the first Si-containing particles 14 coated with the first conductive material 15, and an optional component (for example, the binder or the like) are mixed with the dispersion medium (for example, water) using a known mixing device, stirring device, or the like. It should be noted that the upper layer formation paste preparing step may be performed in parallel to the lower layer formation paste preparing step. The upper layer formation paste preparing step may be performed in parallel to, or after the lower layer forming step.

The lower layer forming step can be performed in accordance with a known method. Specifically, for example, this step can be performed by applying and drying the lower layer formation paste on the negative electrode current collector 62 using a known applying device. By the drying, the lower layer (the second layer 64b) is formed.

The upper layer forming step can be performed in accordance with a known method. Specifically, for example, this step can be performed by applying and drying the upper layer formation paste on the formed lower layer using a known applying device. By the drying, the upper layer (the first layer 64a) is formed and the negative electrode active material layer 64 is formed.

The drying step may be followed by a step of pressing the negative electrode active material layer 64. The pressing step can be performed in accordance with a known method.

By the negative electrode 60 according to this embodiment, the expansion of the negative electrode 60 when the secondary battery is charged and discharged repeatedly can be suppressed. Moreover, since the negative electrode 60 according to this embodiment uses the negative electrode active material containing Si, the capacity of the secondary battery can be increased.

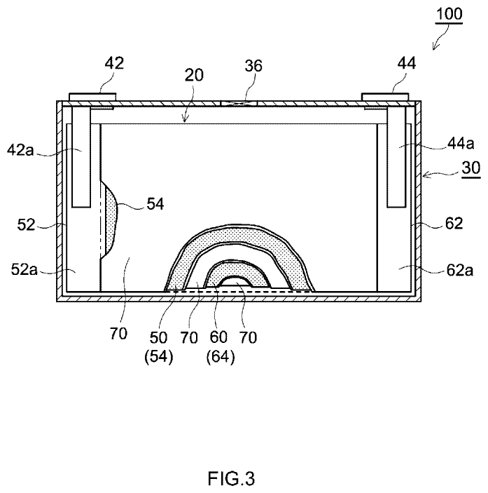

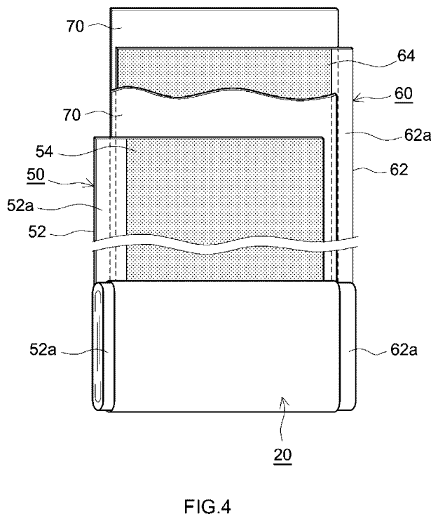

Thus, in another aspect, the secondary battery disclosed herein includes a positive electrode, a negative electrode, and an electrolyte. This negative electrode is the negative electrode 60 according to the aforementioned embodiment. One embodiment of the secondary battery disclosed herein will be described with reference to FIG. 3 and FIG. 4, in which a lithium ion secondary battery is used as one example. In a structure example given below, a lithium ion secondary battery with a flat square shape includes a wound electrode body with a flat shape and a battery case with a flat shape.

As illustrated in FIG. 3, a lithium ion secondary battery 100 is a sealed lithium ion secondary battery 100 constructed in such a way that a wound electrode body 20 with a flat shape and a nonaqueous electrolyte solution (not illustrated) are accommodated inside a battery case (that is, exterior container) 30 with a flat square shape. A battery case 30 includes a positive electrode terminal 42 and a negative electrode terminal 44 for external connection, and a thin safe valve 36 that is set to, when the internal pressure of the battery case 30 has risen to or above a predetermined level, release the internal pressure. The battery case 30 also includes an injection port (not illustrated) for injecting the nonaqueous electrolyte solution. The positive electrode terminal 42 is electrically connected to a positive electrode current collection plate 42a. The negative electrode terminal 44 is electrically connected to a negative electrode current collection plate 44a. As a material of the battery case 30, a metal material with small weight and high thermal conductivity, such as aluminum, is used, for example.

As illustrated in FIG. 3 and FIG. 4, the wound electrode body 20 is in a form in which a positive electrode sheet 50 and a negative electrode sheet 60 are overlapped on each other with two elongated separator sheets 70 therebetween and wound in a longitudinal direction. The positive electrode sheet 50 has a structure in which a positive electrode active material layer 54 is formed along the longitudinal direction on one surface or both surfaces (here, both surfaces) of a positive electrode current collector 52 in an elongated shape. The negative electrode sheet 60 has a structure in which the negative electrode active material layer 64 is formed along the longitudinal direction on one surface or both surfaces (here, both surfaces) of the negative electrode current collector 62 in an elongated shape. A positive electrode active material layer non-formation part 52a (that is, a part where the positive electrode active material layer 54 is not formed and the positive electrode current collector 52 is exposed) and the negative electrode active material layer non-formation part 62a (that is, a part where the negative electrode active material layer 64 is not formed and the negative electrode current collector 62 is exposed) are formed so as to protrude outward from opposite ends of the wound electrode body 20 in a winding axis direction (that is, a sheet width direction that is orthogonal to the longitudinal direction). To the positive electrode active material layer non-formation part 52a and the negative electrode active material layer non-formation part 62a, the positive electrode current collection plate 42a and the negative electrode current collection plate 44a are joined, respectively.

As the positive electrode current collector 52 constituting the positive electrode sheet 50, a known positive electrode current collector that is used for the lithium ion secondary battery may be used and examples thereof include a sheet or a foil made of metal with excellent conductivity (for example, aluminum, nickel, titanium, stainless steel, or the like). The positive electrode current collector 52 is desirably an aluminum foil.

The size of the positive electrode current collector 52 is not limited in particular and may be determined as appropriate in accordance with the battery design. In the case of using the aluminum foil as the positive electrode current collector 52, the thickness is not limited in particular and is, for example, 5 μm or more and 35 μm or less, and desirably 7 μm or more and 20 μm or less.

The positive electrode active material layer 54 contains a positive electrode active material. As the positive electrode active material, a positive electrode active material with a known composition used for the lithium ion secondary battery may be used. Specifically, for example, a lithium composite oxide, a lithium transition metal phosphate compound, or the like can be used as the positive electrode active material. A crystal structure of the positive electrode active material is not limited in particular and may be a layered structure, a spinel structure, an olivine structure, or the like.

As the lithium composite oxide, a lithium transition metal composite oxide containing at least one kind among Ni, Co, and Mn as a transition metal element is desirable. Specific examples thereof include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminum composite oxide, a lithium iron nickel manganese composite oxide, and the like.

It should be noted that the “lithium nickel cobalt manganese composite oxide” herein includes not only oxides including Li, Ni, Co, Mn, and O as constituent elements, but also an oxide further including one or more additive elements besides them. Examples of the additive elements include transition metal elements and typical metal elements such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal element such as S, F, Cl, Br, or I. This also applies, in the same manner, to the lithium nickel composite oxide, the lithium cobalt composite oxide, the lithium manganese composite oxide, the lithium nickel manganese composite oxide, the lithium nickel cobalt aluminum composite oxide, and the lithium iron nickel manganese composite oxide described above.

Examples of the lithium transition metal phosphate compound include lithium iron phosphate (LiFePO₄), lithium manganese phosphate (LiMnPO₄), lithium manganese iron phosphate, and the like.

One kind of these positive electrode active materials may be used alone, or two or more kinds thereof may be used in combination. The positive electrode active material is particularly desirably the lithium nickel cobalt manganese composite oxide because of being excellent in characteristics including an initial resistance characteristic and the like.

The average particle diameter (D50) of the positive electrode active material is not limited in particular and is, for example, 0.05 μm or more and 25 μm or less, desirably 1 μm or more and 20 μm or less, and more desirably 3 μm or more and 15 μm or less.

The positive electrode active material layer 54 may include a component other than the positive electrode active material, such as trilithium phosphate, a conductive material, or a binder. Desired examples of the conductive material include carbon black such as acetylene black (AB), carbon fiber such as vapor grown carbon fiber (VGCF) and carbon nanotube (CNT), and other carbon materials (such as graphite). As the binder, for example, polyvinylidene fluoride (PVdF) or the like can be used.

The content of the positive electrode active material in the positive electrode active material layer 54 (that is, the content of the positive electrode active material with respect to the total mass of the positive electrode active material layer 54) is not limited in particular and is desirably 70 mass % or more, more desirably 80 mass % or more, and still more desirably 85 mass % or more and 99 mass % or less. The content of trilithium phosphate in the positive electrode active material layer 54 is not limited in particular and is desirably 0.1 mass % or more and 15 mass % or less and more desirably 0.2 mass % or more and 10 mass % or less. The content of the conductive material in the positive electrode active material layer 54 is not limited in particular and is desirably 0.1 mass % or more and 20 mass % or less and more desirably 0.3 mass % or more and 15 mass % or less. The content of the binder in the positive electrode active material layer 54 is not limited in particular and is desirably 0.4 mass % or more and 15 mass % or less and more desirably 0.5 mass % or more and 10 mass % or less.

The thickness of the positive electrode active material layer 54 per one side of the positive electrode current collector 52 is not limited in particular and is usually 10 μm or more and desirably 20 μm or more. On the other hand, the thickness is usually 400 μm or less and desirably 300 μm or less.

As the negative electrode sheet 60, the negative electrode 60 described above is used.

As the separator 70, a porous sheet (film) formed of resin such as polyethylene (PE), polypropylene (PP), polyester, cellulose, or polyamide is used. Such a porous sheet may have a single-layer structure or a multilayer structure of two or more layers (for example, a three-layer structure in which a PP layer is stacked on each surface of PE layer). The separator 70 may have a heat resistance layer (HRL) provided on a surface thereof.

The thickness of the separator 70 is not limited in particular and is, for example, 5 μm or more and 50 μm or less and desirably 10 μm or more and 30 μm or less. The air permeability of the separator 70 obtained by a Gurley test is not limited in particular and is desirably 350 seconds/100 cc or less.

The nonaqueous electrolyte solution typically contains a nonaqueous solvent and a supporting salt (electrolyte salt). As the nonaqueous solvent, an organic solvent used for an electrolyte solution of the general lithium ion secondary battery, such as carbonates, ethers, esters, nitriles, sulfones, and lactones, can be used without particular limitations. In particular, carbonates are desirable, and specific examples thereof include ethylene carbonate (EC), propylene carbonate (PC), diethyl carbonate (DEC), dimethyl carbonate (DMC), ethyl methyl carbonate (EMC), monofluoroethylene carbonate (FEC), difluoroethylene carbonate (DFEC), monofluoromethyl difluoromethyl carbonate (F-DMC), trifluorodimethyl carbonate (TFDMC), and the like. One kind of such nonaqueous solvents may be used alone, or two or more kinds thereof may be used in combination. One example of the nonaqueous solvent consists only of carbonates. Another example of the nonaqueous solvent contains carbonates and esters such as methyl acetate.

As the supporting salt, for example, a lithium salt such as LiPF₆, LiBF₄, or lithium bis(fluorosulfonyl)imide (LiFSI) (desirably LiPF₆) can be suitably used. The concentration of the supporting salt is desirably 0.7 mol/L or more and 1.3 mol/L or less.

The nonaqueous electrolyte solution may include a component other than the aforementioned components unless the effect of the present disclosure is deteriorated remarkably. Examples of such a component include various additives such as a film forming agent such as vinylene carbonate (VC) or an oxalato complex, a gas generator such as biphenyl (BP) or cyclohexyl benzene (CHB), and a thickener.

In the lithium ion secondary battery 100, the expansion of the negative electrode when charging and discharging are repeated is suppressed and accordingly, the reaction force is low. In addition, the lithium ion secondary battery 100 has high capacity. The lithium ion secondary battery 100 can be used for various applications. The suitable applications of the lithium ion secondary battery 100 are driving power sources to be mounted on vehicles such as a battery electric vehicle (BEV), a hybrid electric vehicle (HEV), and a plug-in hybrid vehicle (PHEV). The lithium ion secondary battery 100 can be used as an electrical energy storage battery such as a small-sized electrical energy storage device. The lithium ion secondary battery 100 can be used in a form of a battery module, in which a plurality of batteries are typically connected to each other in series and/or in parallel.

As above, the lithium ion secondary battery 100 with the square shape including the wound electrode body 20 with the flat shape has been described as one example. However, the lithium ion secondary battery may be configured as a lithium ion secondary battery including a stacked-type electrode body (that is, an electrode body in which a plurality of positive electrodes and a plurality of negative electrodes are stacked alternately). Alternatively, the lithium ion secondary battery may be configured as a cylindrical lithium ion secondary battery, a laminate-case type lithium ion secondary battery, or the like.

The lithium ion secondary battery 100 may be configured as an all-solid lithium ion secondary battery using a solid electrolyte instead of the nonaqueous electrolyte in accordance with a known method.

The negative electrode 60 according to this embodiment is suitable for the negative electrode for the lithium ion secondary battery; however, the negative electrode 60 can also be constructed and used as a negative electrode for another secondary battery and such a secondary battery can be configured in accordance with a known method.

Examples related to the present disclosure are hereinafter described in detail but these examples are not intended to limit the present disclosure to such examples.

### Manufacture of Negative Electrode

### Example 1

As the negative electrode active material, the following was prepared. It should be noted that the Si content ratios of the first Si-containing particles and the second Si-containing particles were measured using a commercial ICP-OEC device. The average particle diameter (D50) of each of the particles was measured using a commercial laser diffraction/scattering type particle size distribution measurement device.
The first Si-containing particles: Si—C composite material, Si content ratio=35 mass %, average particle diameter (D50)=8 μm
The second Si-containing particles: Si—C composite material, Si content ratio=65 mass %, average particle diameter (D50)=7 μm
The graphite particles (the first graphite particles and the second graphite particles): average particle diameter (D50)=15 μm

The upper layer formation paste including the graphite particles, the first Si-containing particles, the first conductive material, CMC, PAA, and SBR at a mass ratio of 70:30:0.1:1:1:1 was prepared in accordance with the following procedure. In addition, the lower layer formation paste including the graphite particles, the second Si-containing particles, the second conductive material, CMC, PAA, and SBR at a mass ratio of 80:20:0.1:1:1:1 was prepared in accordance with the following procedure.

As the conductive material, the single-walled carbon nanotube (SWCNT) was prepared. The SWCNT was prepared in a form of a dispersion liquid. The first Si-containing particles, the SWCNT dispersion liquid, and the dispersion medium were mixed using a disperser at a rotational speed of 3000 rpm. Thus, the particle in which the surface of the first Si-containing particle was coated with the SWCNT (the first conductive material) was obtained. Similarly, the second Si-containing particles, the SWCNT dispersion liquid, and the dispersion medium were mixed using the disperser at a rotational speed of 3000 rpm. Thus, the particle in which the surface of the second Si-containing particle was coated with the SWCNT (the second conductive material) was obtained.

As the binder, carboxymethyl cellulose (CMC), polyacrylic acid (PAA), and styrene butadiene rubber (SBR) were prepared.

The graphite particles, CMC, and PAA were blended in a dry state using a planetary mixer. The obtained dry mixture and the first Si-containing particles coated with the first conductive material were fed into the planetary mixer together with the dispersant medium, and the mixture was kneaded. In addition, SBR and the additional dispersion medium were fed into the planetary mixer and diluted and mixed, so that the upper layer formation paste was obtained.

The graphite particles, CMC, and PAA were blended in a dry state using a planetary mixer. The obtained dry mixture and the second Si-containing particles coated with the second conductive material were fed into the planetary mixer together with the dispersant medium, and the mixture was kneaded. In addition, SBR and the additional dispersion medium were fed into the planetary mixer and diluted and mixed, so that the lower layer formation paste was obtained.

The prepared lower layer formation paste was applied on a surface of a copper foil with a thickness of 10 μm and dried; thus, the lower layer of the negative electrode active material layer was formed. In addition, the prepared upper layer formation paste was applied on the lower layer and dried; thus, the upper layer was formed. In this manner, the negative electrode active material layer with the multilayer structure was formed. After the negative electrode active material layer was roll-pressed, the obtained sheet was processed into a predetermined size and thus, the negative electrode sheet was obtained.

### Example 2

A negative electrode sheet according to Example 2 was obtained by a method similar to that in Example 1 except that the first Si-containing particles and the second Si-containing particles were changed to the following and the mixing mass ratio of the first conductive material in the upper layer was changed from 0.1 to 0.2.
The first Si-containing particles: Si—C composite material, Si content ratio=40 mass %, average particle diameter (D50)=7 μm
The second Si-containing particles: Si—C composite material, Si content ratio=60 mass %, average particle diameter (D50)=6 μm

### Example 3

A negative electrode sheet according to Example 3 was obtained by a method similar to that in Example 1 except that the ratio (T2/T1) of the thickness (T2) of the upper layer to the thickness (T1) of the lower layer was changed to 10/90.

### Example 4

A negative electrode sheet according to Example 4 was obtained by a method similar to that in Example 1 except that the ratio (T2/T1) of the thickness (T2) of the upper layer to the thickness (T1) of the lower layer was changed to 90/10.

### Example 5

A negative electrode sheet according to Example 5 was obtained by a method similar to that in Example 1 except that the ratio (T2/T1) of the thickness (T2) of the upper layer to the thickness (T1) of the lower layer was changed to 20/80.

### Example 6

A negative electrode sheet according to Example 6 was obtained by a method similar to that in Example 1 except that the ratio (T2/T1) of the thickness (T2) of the upper layer to the thickness (T1) of the lower layer was changed to 80/20.

### Example 7

A negative electrode sheet according to Example 7 was obtained by a method similar to that in Example 1 except that the mixing mass ratio of the second conductive material in the lower layer was changed from 0.5 to 0.3.

### Example 8

A negative electrode sheet according to Example 8 was obtained by a method similar to that in Example 1 except that the mixing mass ratio of the first conductive material in the upper layer was changed from 0.1 to 0.2 and the mixing mass ratio of the second conductive material in the lower layer was changed from 0.5 to 0.4.

### Comparative Example 1

The lower layer formation paste and the upper layer formation paste were mixed so that the mass ratio of the solid contents of these became 1:1; thus, a negative electrode active material layer formation paste was manufactured. This paste was applied on a surface of a copper foil with a thickness of 10 μm and dried; thus, the negative electrode active material layer was formed. After the negative electrode active material layer was roll-pressed, the obtained sheet was processed into a predetermined size and thus, a negative electrode sheet according to Comparative Example 1 was obtained. It should be noted that the thickness of the negative electrode sheet according to Comparative Example 1 was the same as that in Example 1.

### Comparative Example 2

A negative electrode sheet according to Comparative Example 2 was obtained by a method similar to that in Example 1 except that the lower layer was formed using the upper layer formation paste and the upper layer was formed using the lower layer formation paste. Therefore, in Comparative Example 2, the first Si-containing particles coated with the first conductive material and the second Si-containing particles coated with the second conductive material were exchanged.

### Comparative Example 3

A negative electrode sheet according to Comparative Example 3 was obtained by a method similar to that in Example 1 except that the mixing mass ratio of the first conductive material in the upper layer was changed from 0.1 to 0.5.

### Comparative Example 4

A negative electrode sheet according to Comparative Example 4 was obtained by a method similar to that in Example 1 except that the mixing mass ratio of the second conductive material in the lower layer was changed from 0.5 to 0.1.

### Comparative Example 5

The lower layer formation paste was applied on a surface of a copper foil with a thickness of 10 μm and dried; thus, the negative electrode active material layer was formed. After the negative electrode active material layer was roll-pressed, the obtained sheet was processed into a predetermined size and thus, a negative electrode sheet according to Comparative Example 5 was obtained. It should be noted that the thickness of the negative electrode sheet according to Comparative Example 5 was the same as that in Example 1.

### <Evaluation of Expansion Rate of Electrode Plate>

The thickness of the negative electrode according to each of Examples and Comparative Examples was measured. This thickness was defined as an initial thickness (T0). Using this negative electrode, an evaluation lithium ion secondary battery was manufactured as follows.

LiNi_{1/3}Co_{1/3}Mn_{1/3}O₂ (NCM) as positive electrode active material powder, acetylene black (AB) as the conductive material, and polyvinylidene fluoride (PVdF) as the binder were mixed with N-methyl pyrrolidone (NMP) at a mass ratio of NCM:AB:PVdF=100:1:1; thus, the positive electrode paste was prepared. This paste was applied on a surface of an aluminum foil with a thickness of 15 μm and dried; thus, the positive electrode active material layer was formed. After the positive electrode active material layer was roll-pressed, the obtained sheet was processed into a predetermined size and thus, the positive electrode sheet was obtained.

A separator made of porous polyolefin was prepared. A lead was attached to each of the manufactured negative electrode sheet and positive electrode sheet, the sheets were stacked with the separator therebetween, and thus, the electrode body was manufactured. This was accommodated together with the nonaqueous electrolyte solution in a case made of an aluminum laminate film. The nonaqueous electrolyte solution used was prepared in such a way that LiPF₆ as the supporting salt was dissolved at a concentration of 1.0 mol/L in a mixed solvent containing ethylene carbonate (EC), fluoroethylene carbonate (FEC), ethyl methyl carbonate (EMC), and dimethyl carbonate (DMC) at a volume ratio of 15:5:40:40. After that, the case was sealed and thus, the evaluation lithium ion secondary battery was obtained.

Next, each evaluation lithium ion secondary battery manufactured as above was placed under an environment of 25° C. After each evaluation lithium ion secondary battery was subjected to constant-current charging to 4.2 V at a current value of 0.4 C, constant-voltage charging was performed until the current value became 0.1 C. Subsequently, each evaluation lithium ion secondary battery was subjected to constant-current discharging to 2.5 V at a current value of 0.4 C.

The charging and discharging described above were regarded as one cycle, and 250 cycles of charging and discharging were repeated. Each evaluation lithium ion secondary battery was disassembled in an argon atmosphere, the negative electrode was immersed and cleaned in DMC, and then drying was performed. Subsequently, the thickness of the negative electrode was measured and this thickness was defined as a thickness (Tc) after the charging and discharging cycles. The change rate (%) of the thickness of the negative electrode before and after the charging and discharging cycles was calculated based on (Tc/T0−1)×100. The results are shown in Table 1.

TABLE 1

| | | | First Si-containing particle | | | Second Si-containing particle | | | | |
|---|---|---|---|---|---|---|---|---|---|---|
| | | | | | Coating | | | Coating | | |
| | Structure of | | | Conductive | amount C1 | | Conductive | amount C2 | | Expansion |
| | active | Thickness | Si content | material | (mass %) of | Si content | material | (mass %) of | | rate of |
| | material | ratio | ratio | mixing | conductive | ratio | mixing | conductive | | electrode |
| | layer | T2/T1 | (mass %) | ratio | material | (mass %) | ratio | material | C2/C1 | plate (%) |
| Example 1 | Two layers | 50/50 | 35 | 0.1 | 0.33 | 65 | 0.5 | 2.5 | 7.5 | 35 |
| Example 2 | Two layers | 50/50 | 40 | 0.2 | 0.67 | 60 | 0.5 | 2.5 | 3.75 | 38 |
| Example 3 | Two layers | 10/90 | 35 | 0.1 | 0.33 | 65 | 0.5 | 2.5 | 7.5 | 41 |
| Example 4 | Two layers | 90/10 | 35 | 0.1 | 0.33 | 65 | 0.5 | 2.5 | 7.5 | 43 |
| Example 5 | Two layers | 20/80 | 35 | 0.1 | 0.33 | 65 | 0.5 | 2.5 | 7.5 | 39 |
| Example 6 | Two layers | 80/20 | 35 | 0.1 | 0.33 | 65 | 0.5 | 2.5 | 7.5 | 42 |
| Example 7 | Two layers | 50/50 | 35 | 0.1 | 0.33 | 65 | 0.3 | 1.5 | 4.5 | 39 |
| Example 8 | Two layers | 50/50 | 35 | 0.2 | 0.67 | 65 | 0.4 | 2.0 | 3 | 40 |
| Comparative | Single layer | — | 35 | 0.1 | 0.33 | 65 | 0.5 | 2.5 | 7.5 | 54 |
| Example 1 | | | | | | | | | | |
| Comparative | Two layers | 50/50 | 65 | 0.5 | 2.5 | 35 | 0.1 | 0.33 | 0.13 | 60 |
| Example 2 | | | | | | | | | | |
| Comparative | Two layers | 50/50 | 35 | 0.5 | 1.67 | 65 | 0.5 | 2.5 | 1.5 | 51 |
| Example 3 | | | | | | | | | | |
| Comparative | Two layers | 50/50 | 35 | 0.1 | 0.33 | 65 | 0.1 | 0.5 | 1.5 | 62 |
| Example 4 | | | | | | | | | | |
| Comparative | Single layer | — | — | — | — | 65 | 0.5 | 2.5 | — | 68 |
| Example 5 | | | | | | | | | | |

From the results shown in Table 1, it can be understood that indicate that the expansion rate of the electrode plate is very low in the case where the first Si-containing particles with the low Si content ratio coated with the first conductive material are used in addition to the first graphite particles in the upper layer of the negative electrode active material layer, and the second Si-containing particles with the high Si content ratio coated with the second conductive material with the coating amount 2.5 times or more larger than that of the first Si-containing particle are used in addition to the second graphite particles in the lower layer of the negative electrode active material layer. Accordingly, it can be understood that according to the negative electrode of the present disclosure, the expansion of the negative electrode when the secondary battery is charged and discharged repeatedly is small although the negative electrode including the Si-containing particles and the graphite particles is used.

The specific examples of the present disclosure have been described above in detail; however, these are just examples and will not limit the scope of claims. The techniques described in the scope of claims include those in which the specific examples exemplified above are variously modified and changed.

That is to say, the following Items [1] to [9] are given as the negative electrode of the secondary battery, and the secondary battery disclosed herein.
[1] The negative electrode including:
   the negative electrode current collector; and
   the negative electrode active material layer supported by the negative electrode current collector, in which
   the negative electrode active material layer includes the first layer existing on the side of the surface layer part and the second layer existing on the side of the negative electrode current collector,
   the first layer includes the first graphite particles and the first Si-containing particles,
   the second layer includes the second graphite particles and the second Si-containing particles,
   the Si content ratio in the first Si-containing particle is smaller than the Si content ratio in the second Si-containing particle,
   each of the first Si-containing particle and the second Si-containing particle is coated with the conductive material, and
   the ratio of the coating amount (mass %) of the conductive material for the second Si-containing particle to the coating amount (mass %) of the conductive material for the first Si-containing particle is 2.5 or more.
[2] The negative electrode according to Item [1], in which the conductive material is the carbon nanotube.
[3] The negative electrode according to Item [2], in which the coating amount of the conductive material for the first Si-containing particle is 0.05 mass % to 2.0 mass %, and the coating amount of the conductive material for the second Si-containing particle is 0.10 mass % to 3.0 mass %.
[4] The negative electrode according to any one of Items [1] to [3], in which the ratio of the thickness of the second layer to the thickness of the first layer is 10/90 to 90/10.
[5] The negative electrode according to any one of Items [1] to [4], in which the ratio of the Si content ratio in the first Si-containing particle to the Si content ratio in the second Si-containing particle is 0.10 to 0.90.
[6] The negative electrode according to any one of Items [1] to [5], in which the Si content ratio in the first Si-containing particle is 20 mass % to 55 mass %, and the Si content ratio in the second Si-containing particle is 45 mass % to 80 mass %.
[7] The negative electrode according to any one of Items [1] to [6], in which each of the first Si-containing particles and the second Si-containing particles is the particles of the Si—C composite material.
[8] The negative electrode according to any one of Items [1] to [7], in which
   in the first layer, the mass ratio of the first Si-containing particles to the total of the first graphite particles and the first Si-containing particles is 10 mass % to 60 mass %, and
   in the second layer, the mass ratio of the second Si-containing particles to the total of the second graphite particles and the second Si-containing particles is 10 mass % to 60 mass %.
[9] The secondary battery including the positive electrode, the negative electrode, and the electrolyte, in which the negative electrode is the negative electrode according to any one of Items [1] to [8].

What is claimed is:

1. A negative electrode comprising:
a negative electrode current collector; and
a negative electrode active material layer supported by the negative electrode current collector, wherein
the negative electrode active material layer includes a first layer existing on a side of a surface layer part and a second layer existing on a side of the negative electrode current collector,
the first layer includes first graphite particles and first Si-containing particles,
the second layer includes second graphite particles and second Si-containing particles,
a Si content ratio in the first Si-containing particle is smaller than a Si content ratio in the second Si-containing particle,
each of the first Si-containing particle and the second Si-containing particle is coated with a conductive material, and
a ratio of a coating amount (mass %) of the conductive material for the second Si-containing particle to a coating amount (mass %) of the conductive material for the first Si-containing particle is 2.5 or more.

2. The negative electrode according to claim 1, wherein the conductive material is a carbon nanotube.

3. The negative electrode according to claim 2, wherein the coating amount of the conductive material for the first Si-containing particle is 0.05 mass % to 2.0 mass %, and the coating amount of the conductive material for the second Si-containing particle is 0.10 mass % to 3.0 mass %.

4. The negative electrode according to claim 1, wherein a ratio of a thickness of the second layer to a thickness of the first layer is 10/90 to 90/10.

5. The negative electrode according to claim 1, wherein a ratio of the Si content ratio in the first Si-containing particle to the Si content ratio in the second Si-containing particle is 0.10 to 0.90.

6. The negative electrode according to claim 1, wherein the Si content ratio in the first Si-containing particle is 20 mass % to 55 mass %, and the Si content ratio in the second Si-containing particle is 45 mass % to 80 mass %.

7. The negative electrode according to claim 1, wherein each of the first Si-containing particles and the second Si-containing particles is particles of a Si—C composite material.

8. The negative electrode according to claim 1, wherein
in the first layer, a mass ratio of the first Si-containing particles to a total of the first graphite particles and the first Si-containing particles is 10 mass % to 60 mass %, and
in the second layer, a mass ratio of the second Si-containing particles to a total of the second graphite particles and the second Si-containing particles is 10 mass % to 60 mass %.

9. A secondary battery comprising a positive electrode, a negative electrode, and an electrolyte, wherein the negative electrode is the negative electrode according to claim 1.
